(19) United States
(12) Patent Application Publication
(10) Pub. No.: US 2011/0148704 A1
(43) Pub. Date: Jun. 23, 2011

(54) BEAM STEERING APPARATUS

(75) Inventor: Dong-Ho KIM, Daejeon-si (KR)

(73) Assignee: Electronics and Telecommunications Research Institue, Daejeon-si (KR)

(21) Appl. No.: 12/900,689

(22) Filed: Oct. 8, 2010

(30) Foreign Application Priority Data
Dec. 18, 2009 (KR) 10-2009-0127290

(51) Int. Cl. H01Q 3/00

(52) U.S. Cl. 342/368

(57) ABSTRACT

A beam steering apparatus is provided. The beam steering apparatus is implemented to steer a beam in a specific direction according to arrangement of a plurality of unit structures which have different transmittance coefficients and are arranged on a medium. Thus, simplification of the application of the beam steering apparatus to an antenna and the like, a compact beam steering apparatus size, and reduction of manufacturing cost can be realized.

### CROSS-REFERENCE TO RELATED APPLICATION

This application claims the benefit under 35 U.S.C. §119(a) of Korean Patent Application No. 10-2009-0127290, filed on Dec. 18, 2009, the entire disclosure of which is incorporated herein by reference for all purposes.

### BACKGROUND

1. Field

The following description relates to a beam steering technique, and more particularly, to a beam steering apparatus using an arrangement of conductors, dielectrics, or magnetic substances.

2. Description of the Related Art

Generally, in optical fields, a traveling direction of a beam of visible light is changed by a prism or reflection minor. In the case of using a prism, a beam (light) passing through the prism curves in a specific direction according to an angle of the prism and a difference of refractive index between the prism and air. In the case of using a reflection mirror, a plurality of reflection minors are used to reflect and steer the beam (light) in a desired direction.

In fields that use non-visible rays of light, for example, in an antenna technique using a frequency in the microwave band, reflectors with various shapes are used to steer the beam. For example, in a reflector antenna, an electromagnetic wave emitted from a feed horn antenna is reflected by reflectors of various shapes, and is directed in a particular direction. Examples of the shapes of the reflectors may include a flat plane, a corner-shape, a parabola-shape, and the like.

Alternatively, without using a reflector, a beam of light can be steered by use of a phased array antenna. The phased array antenna serves to steer a beam through phase arrays of a plurality of antennas, and to steer a beam by adjusting phases and amplitudes of signals fed to the respective antennas to correspond to a steering direction and an amplitude of the overall beam.

Recently, a method of steering a beam by adjusting a reflection phase of an artificial magnetic conductor (AMC) has been introduced.

### SUMMARY

The following description relates to a beam steering apparatus which can steer a beam in a desired direction by arranging a plurality of unit structures having different transmittance coefficients in a specific pattern on a medium.

In one general aspect, provided is a beam steering apparatus including: a medium; and one or more structure groups, each configured to comprise a plurality of unit structures with different coefficients which are arranged in series on the medium.

Other features and aspects will be apparent from the following detailed description, the drawings, and the claims.

### BRIEF DESCRIPTION OF THE DRAWINGS

FIG. 1 is a diagram illustrating an example showing a beam steering concept of a beam steering apparatus.

FIG. 2 is a diagram illustrating an example of a beam steering apparatus.

FIG. 3 is a diagram illustrating another example of a beam steering apparatus.

FIG. 4 is a diagram illustrating another example of a beam steering apparatus.

FIG. 5 is a diagram illustrating another example of a beam steering apparatus.

FIG. 6 is a diagram illustrating an example of a unit structure pattern.

FIG. 7 is a diagram illustrating another example of a unit structure pattern.

FIG. 8 is a diagram illustrating another example of a unit structure pattern.

FIG. 9 is a diagram illustrating another example of a unit structure pattern.

FIG. 10 is a diagram illustrating an example of a beam steering apparatus applied in an antenna system.

FIG. 11 is a graph of an example showing maximum radiation gains according to the presence of a beam steering apparatus.

FIG. 12 is a graph of an example showing primary radiation beam directions of antennas, one having a beam steering apparatus of a single layer and another having a beam steering apparatus of two stacked layers.

FIG. 13 is a graph of an example showing radiation patterns of antennas according to the use of a beam steering apparatus.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

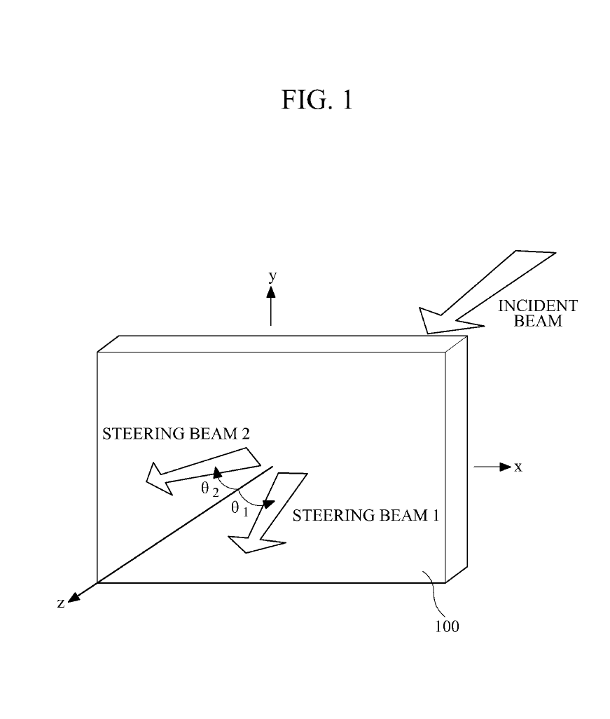

FIG. 1 illustrates a diagram of an example showing a concept of beam steering by a beam steering apparatus. Referring to FIG. 1, while an incident wave, that is, a beam incident in the positive z direction passes through the beam steering apparatus 100, the direction of the beam is steered in a direction of θ₁ or θ₂ and travels in that direction. In this case, a steering angle θ₁ or θ₂ may be parallel to an x-axis or a y-axis, or may not be parallel to any axes. In other words, the beam may curve in an arbitrary direction.

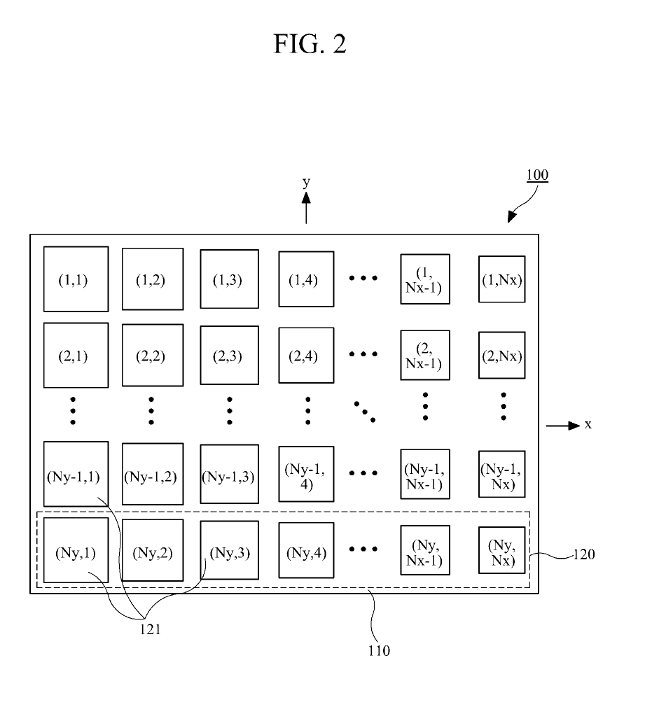

FIGS. 2 to 5 illustrate diagrams of examples of a beam steering apparatus. As shown in the examples illustrated in FIGS. 2 to 5, the beam steering apparatus 100 may include media 110 and structure groups 120.

Each medium 110 may be a dielectric or magnetic substance. Each structure group 120 includes a plurality of unit structures 121 which have different transmittance coefficients and are arranged in series with one another on the medium 110. Each of the unit structures 121 may be a conductor, a dielectric, or a magnetic substance, and be in various forms such as a rectangle as shown in FIGS. 2 to 5.

For example, the transmittance coefficients may vary according to sizes of the unit structures 121. In this case, the unit structures 121 having different sizes are arranged in series with one another on the medium 110 to form the structure group 120. The transmittance coefficients may vary according to the shapes or materials of the unit structures 121.

The plurality of structure groups 120 may be arranged in rows or columns on the medium 110. Referring to FIG. 2, it is noted that a plurality of structure groups 120 including a number of unit structures 121 having different transmittance coefficients are arranged in rows.

The beam steering apparatus 100 has a specified transmittance coefficient size and phase according to sizes, shapes, or materials of the unit structures 121 arranged on the medium 110. To steer a beam in a desired direction, a plane of a beam (wave) should be formed, and transmittance coefficients of the respective unit structures 121 are designed to result in a phase difference sufficient to form the plane of a beam (wave), thereby refracting a wave in a desired direction.

In another example, the structure group 120 may include a plurality of unit structures arranged in increasing order of transmittance coefficient in one direction.

For example, as shown in FIG. 2, the structure group 120 may include a plurality of unit structures arranged from the left to the right in increasing order of transmittance coefficients.

The beam steering apparatus 100 steers a beam in a single direction, and includes a plurality of structure groups 120 arranged in rows, and each of the structure groups 120 includes a plurality of unit structures arranged from the left to the right in decreasing order of sizes (i.e., increasing order of transmittance coefficients). The beam passing through the beam steering apparatus 120 is refracted in the positive x direction.

Alternatively, although not illustrated, each of the structure group 120 may include a plurality of unit structures arranged from the right to the left in increasing order of transmittance coefficients.

Moreover, although not illustrated, each of the structure groups 120 may include a plurality of unit structures arranged from the top to the bottom in increasing order of transmittance coefficients.

Furthermore, although not illustrated, each of the structure groups 120 may include a plurality of unit structures arranged from the bottom to the top in increasing order of transmittance coefficients.

Thus, by implementing the structure groups 120 as described above, a beam can be steered in one of upward, downward, leftward, and rightward directions.

In another example, each of the structure groups 120 may include a plurality of unit structures arranged symmetrically, wherein a unit structure having the lowest transmittance coefficient is placed at the center.

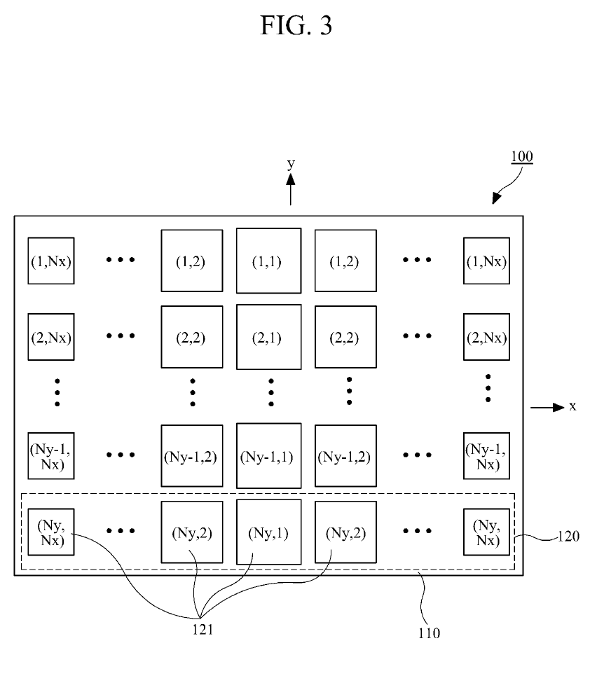

For example, as shown in FIG. 3, the structure group 120 may have a plurality of unit structures 121 which are arranged horizontally symmetrically relative to a unit structure having the lowest transmittance coefficient.

The beam steering apparatus 100 shown in the example illustrated in FIG. 3 steers a beam in two directions, and includes a plurality of structure groups 120. Each of the structure groups 120 includes a plurality of unit structures 121 arranged symmetrically relative to a unit structure having the largest size (i.e., the lowest transmittance coefficient). A beam passing through the beam steering apparatus 100 is refracted in the positive x and the negative x directions (the left and the right directions in FIG. 3.

Alternatively, although not illustrated, each of the structure groups 120 may include a plurality of unit structures arranged vertically symmetrically relative to a unit structure having the lowest transmittance coefficient.

In addition, although not illustrated, each of the structure groups 120 may include a plurality of unit structures arranged radially symmetrically relative to a unit structure having the lowest transmittance coefficient.

Thus, through the above implementation, a beam may be steered in upward/downward directions, leftward/rightward directions, or all directions.

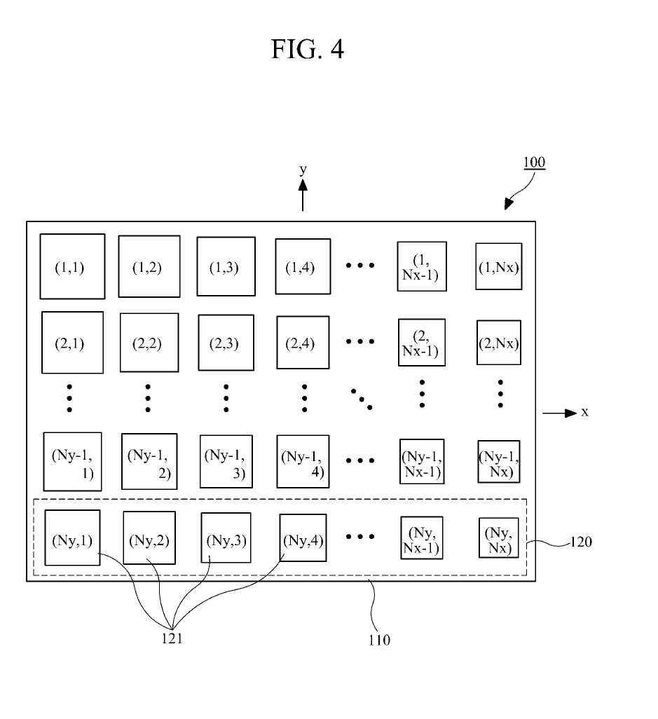

Although the beam steering apparatus 100 shown in the example illustrated in FIG. 4 is similar to the beam steering apparatus 100 shown in the example illustrated in FIG. 2 in that the beam steering apparatus 100 includes a plurality of structure groups 120 in rows, each of the structure groups 120 including a plurality of unit structures arranged from the left to the right in decreasing order of sizes (i.e., increasing order of transmittance coefficients), the unit structures of the structure groups 120 of the beam steering apparatus 100 of FIG. 4 are arranged in a manner that the sizes of the unit structures become smaller downward from the top structure group 120 to the bottom. Hence, a beam passing through the beam steering apparatus 100 is refracted in a (+x, −y) direction (in the bottom-right direction in FIG. 4).

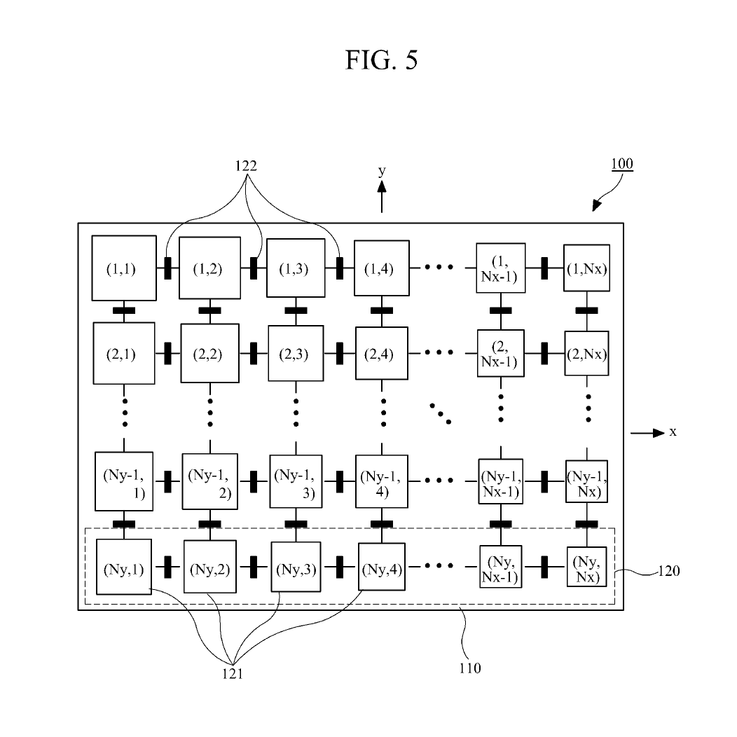

In another example, as shown in FIG. 5, each of the structure groups 120 may further include auxiliary units 122 connected between the unit structures 121 to adjust a beam steering direction.

The auxiliary units 122 may include passive elements, resistance elements, for example, resistors, capacitance elements, for example, capacitors, or inductive elements, for example, inductors. Alternatively, the auxiliary units 122 may include active elements such as diodes, varactors, or bias circuits.

That is, by use of changes of characteristics, for example, resistance characteristics, capacitance characteristics, or inductive characteristics, of the auxiliary units 122 connected between the unit structures 121 of the respective structure groups 120, transmittance coefficient phases of the respective unit structures 121 are changed to adjust the beam steering directions.

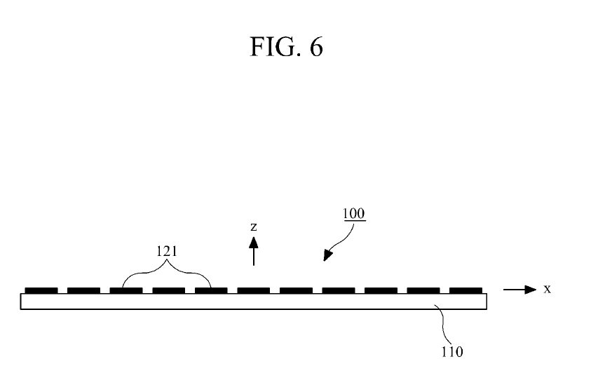

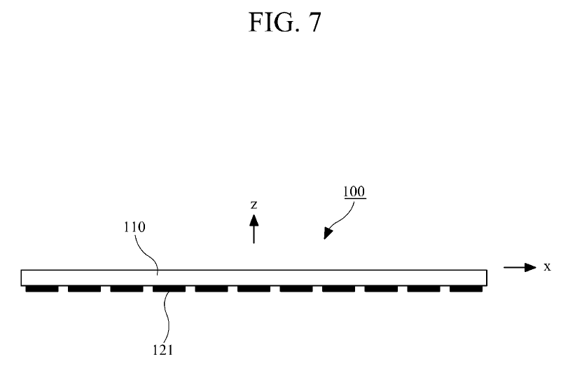

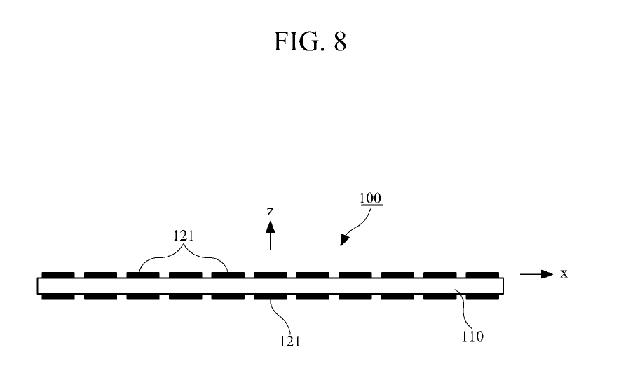

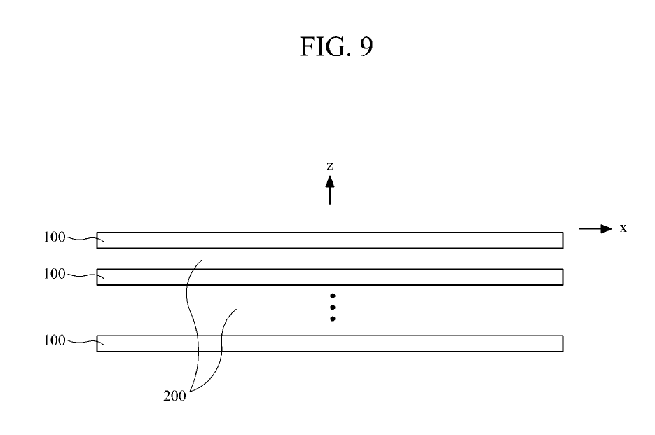

FIGS. 6 to 9 illustrate diagrams of examples of unit structure patterns of a beam steering apparatus 100. FIG. 6 illustrates a diagram of an example showing a plurality of unit structures 121 which have different transmittance coefficients and are patterned on a top surface of a medium 110. FIG. 7 illustrates an example showing a plurality of unit structures 121 which have different transmittance coefficients and are patterned on a lower surface of a medium 110. FIG. 8 illustrates an example showing a plurality of unit structures 121 which have different transmittance coefficients and are patterned on both top and lower surfaces of a medium 110. FIG. 9 illustrates an example showing a plurality of beam steering apparatuses 100 of examples illustrated in FIGS. 6 to 8 which are stacked on one another. Reference numeral 200 in FIG. 9 denotes a spacer used for stacking the beam steering apparatuses 100.

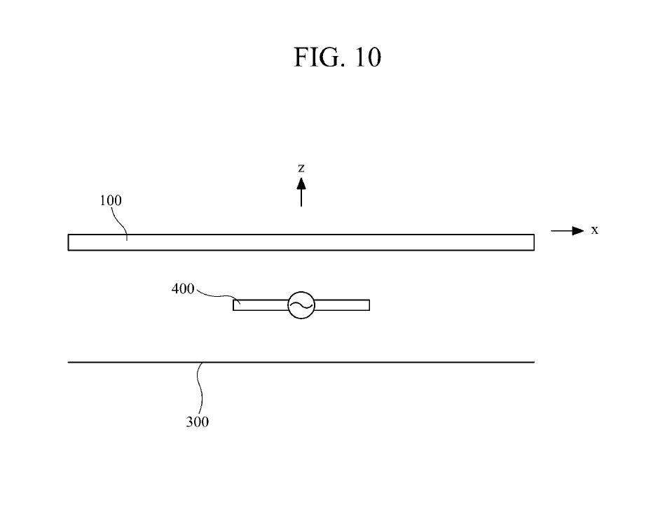

FIG. 10 illustrates a diagram of an example of a beam steering apparatus applied in an antenna system. Referring to FIG. 10, the antenna system includes a dipole antenna 400 placed between the beam steering apparatus 100 and a ground 300, and steers and emits a beam (wave) from the dipole antenna in a desired direction.

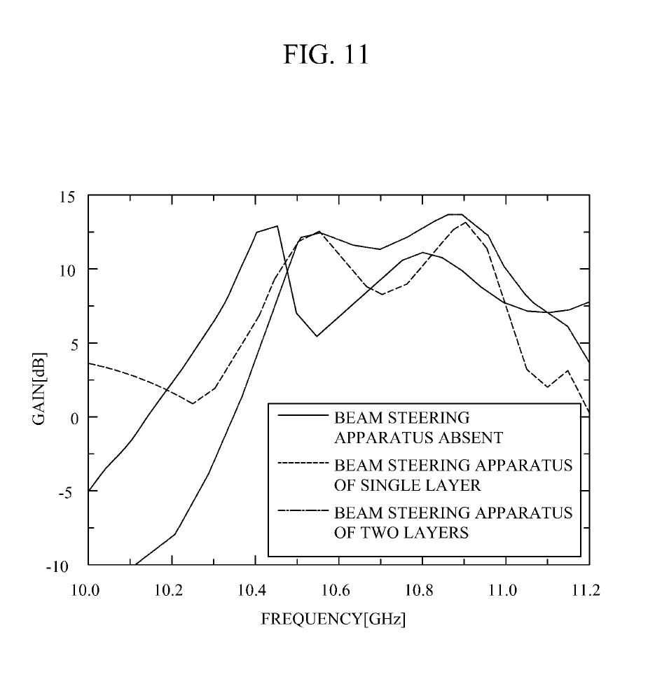

FIG. 11 illustrates a graph of an example showing maximum radiation gains according to the presence of a beam steering apparatus. Referring to FIG. 11, there are no significant differences in maximum radiation gains between an antenna using a beam steering apparatus of a single layer, an antenna using a beam steering apparatus of two stacked layers, and an antenna having no beam steering apparatus. That is, it is noted that the use of the beam steering apparatus described above does not significantly affect the maximum radiation gain of an antenna.

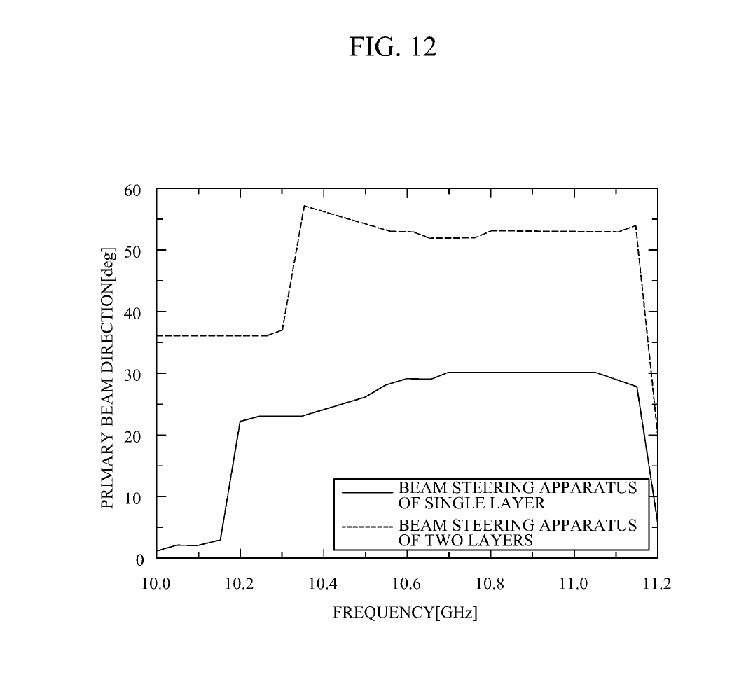

FIG. 12 illustrates a graph of an example showing primary radiation beam directions of antennas, one having a beam steering apparatus of a single layer and another having a beam steering apparatus of two stacked layers. Referring to FIG. 12, a refraction angle of a primary beam is greater in the beam steering apparatus of two stacked layers than the beam steering apparatus of a single layer, and thus the beam is steered more by the beam steering apparatus of two stacked layers.

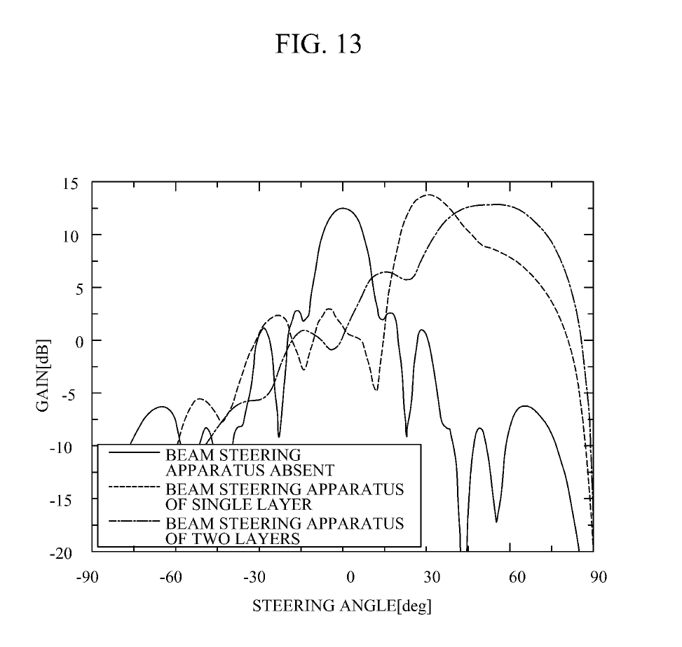

FIG. 13 illustrates a graph of an example showing radiation patterns of antennas according to the use of a beam steering apparatus. The graph in FIG. 13 shows radiation patterns at the maximum frequencies of the antennas shown in the example illustrated in FIG. 11.

As shown in FIG. 13, if an antenna which has emitted a beam in a direction at a steering angle of ‘Theta=0’ without use of a beam steering apparatus utilizes a beam steering apparatus of a single layer, a beam is steered at the steering angle of ‘Theta=30°’ and if utilizing a beam steering apparatus of two stacked layers, a beam is steered at the steering angle of ‘Theta=53°.’

As described above, the beam steering apparatus can steer a beam in a specific direction according to arrangement of a plurality of unit structures having different transmittance coefficients on a medium. Thus, the beam steering apparatus does not require a complicated signal provision network, a signal phase converter, and a power distributor, thereby simplifying the application of the beam steering apparatus to an antenna, achieving a compact beam steering apparatus, and reducing manufacturing cost.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A beam steering apparatus comprising:
a medium; and
one or more structure groups, each configured to comprise a plurality of unit structures with different coefficients which are arranged in series on the medium.

2. The beam steering apparatus of claim 1, wherein the structure group is configured to comprise the plurality of unit structures arranged in one direction in increasing order of transmittance coefficients.

3. The beam steering apparatus of claim 2, wherein the structure group is configured to comprise the plurality of unit structures arranged from the left to the right in increasing order of transmittance coefficients.

4. The beam steering apparatus of claim 2, wherein the structure group is configured to comprise the plurality of unit structures arranged from the right to the left in increasing order of transmittance coefficients.

5. The beam steering apparatus of claim 2, wherein the structure group is further configured to comprise the plurality of unit structures arranged from the top to the bottom in increasing order of transmittance coefficients.

6. The beam steering apparatus of claim 2, wherein the structure group is configured to comprise the plurality of unit structures arranged from the bottom to the top in increasing order of transmittance coefficients.

7. The beam steering apparatus of claim 1, wherein the structure group is configured to comprise the plurality of unit structures arranged symmetrically wherein a unit structure having the lowest transmittance coefficient is placed at the center.

8. The beam steering apparatus of claim 7, wherein the structure group is configured to comprise the plurality of unit structures arranged horizontally symmetrically wherein a unit structure having the lowest transmittance coefficient is placed at the center.

9. The beam steering apparatus of claim 7, wherein the structure group is configured to comprise the plurality of unit structures arranged vertically symmetrically wherein a unit structure having the lowest transmittance coefficient is placed at the center.

10. The beam steering apparatus of claim 7, wherein the structure group is configured to comprise the plurality of unit structures arranged radially symmetrically wherein a unit structure having the lowest transmittance coefficient is placed at the center.

11. The beam steering apparatus of claim 1, wherein a plurality of the structure groups are arranged in rows on the medium.

12. The beam steering apparatus of claim 1, wherein a plurality of the structure groups are arranged in columns on the medium.

13. The beam steering apparatus of claim 1, wherein the structure group is configured to further comprise auxiliary units configured to be connected between the unit structures and adjust a beam steering direction.

14. The beam steering apparatus of claim 1, wherein the transmittance coefficients vary according to sizes of the unit structures.

15. The beam steering apparatus of claim 1, wherein the unit structures are conductors, dielectrics, or magnetic substances.

16. The beam steering apparatus of claim 1, wherein the medium is a dielectric or a magnetic substance.
